(19) United States
(12) Patent Application Publication
(10) Pub. No.: US 2023/0195323 A1
(43) Pub. Date: Jun. 22, 2023

(54) METHOD AND SYSTEM FOR REDUCING RECONSTRUCTED DATA BY MEANS OF CHANGING STORAGE MEDIUMS IN STORAGE CLUSTER

(71) Applicant: INSPUR SUZHOU INTELLIGENT TECHNOLOGY CO., LTD., Suzhou, Jiangsu (CN)

(72) Inventors: Genling WANG, Suzhou, Jiangsu (CN); Xiangrui MENG, Suzhou, Jiangsu (CN)

(21) Appl. No.: 17/927,828

(22) PCT Filed: Jan. 22, 2021
(86) PCT No.: PCT/CN2021/073325

§ 371 Date: Nov. 25, 2022

(30) Foreign Application Priority Data
May 28, 2020 (CN) 202010470074.7

(51) Int. Cl. G06F 3/06

(52) U.S. Cl. CPC G06F 3/0617; G06F 3/0644; G06F 3/0689

(57) ABSTRACT

The method includes the following steps: acquiring originally distributed OSD lists of placement groups (PGs) in a cluster storage pool (S1); when disk replacement occurs in the cluster storage pool, acquiring newly distributed OSD lists of the placement groups (PGs) in the cluster storage pool (S2); calculating the difference terms between the originally distributed OSD lists and the newly distributed OSD lists of the placement groups (PGs), and generating a difference comparison table (S3); traversing the difference comparison table to sequentially delete a replacement hard disk, in the corresponding newly distributed OSD list, of the difference term of each placement group(PG), so as to obtain a placement group (PG) with additional OSD changes, and generating a difference correction table(S4); and applying the difference correction table to correct the placement group (PG) with the additional OSD changes to be originally distributed (S5).

### CROSS REFERENCE TO RELATED APPLICATION

The present disclosure claims the priority of the Chinese patent application filed on May 28^{th}, 2020 before the CNIPA, China National Intellectual Property Administration with the application number of 202010470074.7 and the title of “METHOD AND SYSTEM FOR REDUCING RECONSTRUCTED DATA BY MEANS OF CHANGING STORAGE MEDIUMS IN STORAGE CLUSTER”, which is incorporated herein in its entirety by reference.

### TECHNICAL FIELD

The present disclosure belongs to the technical field of distributed storage, and particularly to a method and system for reducing reconstruct data due to storage medium changes in a storage cluster.

### BACKGROUND

OSD is the abbreviation of Object-based Storage Device. A device based on object storage technology is an object storage device, that is, a storage medium, corresponding to a hard disk in a storage cluster.

Placement group (PG) is a logical unit for data distribution.

Storage pools are the basis of distributed storage systems. Generally, a storage system consists of multiple storage pools. When created, a storage pool specifies a data storage mode, such as copy mode or correcting deletion mode. After the storage pool is created, corresponding placement groups PGs will be generated. Placement group PG is a virtual concept, and taking three copies in the copy mode as an example, in order to realize high availability, a placement group PG respectively calculates three OSDs through a pseudo-random algorithm for data storage, that is, each placement group PG has corresponding OSD lists. For example, an OSD list of a placement group PG is [6 1 11].

In the use of the cluster, hard disk failures may occur due to some reasons (service life, abnormal power failure, etc.), resulting in the need for hard disk replacement. After the hard disk replacement, placement group PG distributions (OSD lists) are again calculated through the pseudo-random algorithm. Placement groups PGs involving the replacement hard disk will generate data migration. However, due to the unstable pseudo-random algorithm, a certain number of OSD list changes will also occur in placement groups PGs not involving the hard disk replacement, resulting in unnecessary data migration. The larger the number of clusters, the longer the migration time, and the more obvious the problem. Currently, there is no effective optimization for this problem.

This is a defect of the existing technology. Therefore, it is very necessary to provide a method and system for reducing reconstruct data due to storage medium changes in the storage cluster, in view of the above defect.

### SUMMARY

In view of the defect of the existing technology that the unstable pseudo-random algorithm causes the occurrence of a certain number of OSD list changes in the placement groups PGs not involving the hard disk replacement to result in unnecessary data migration, the present disclosure provides a method and system for reducing reconstruct data due to storage medium changes in a storage cluster, to solve the above technical problem.

In a first aspect, the present disclosure provides for reducing reconstruct data due to storage medium changes in the storage cluster, including the following steps:
S1. obtaining originally distributed OSD lists of placement groups PGs in a cluster storage pool;
S2. obtaining newly distributed OSD lists of the placement groups PGs in the cluster storage pool when disk replacement occurs in the cluster storage pool;
S3. calculating difference items between the originally distributed OSD lists and the newly distributed OSD lists of the placement groups PGs to generate a difference comparison table;
S4. traversing the difference comparison table to sequentially delete replacement hard disks, in the corresponding newly distributed OSD lists, of the difference items of each placement group PG, to obtain placement groups PGs with extra OSD changes, and generating a difference correction table; and
S5. applying the difference correction table to correct the placement groups PGs with the extra OSD changes to be originally distributed.

Further, steps of Step S2 are as follows:
S21. determining whether the disk replacement occurs in the cluster storage pool;
under a condition that the disk replacement occurs in the cluster storage pool, entering Step S22;
under a condition that the disk replacement does not occur in the cluster storage pool, returning to Step S21; and
S22. obtaining the newly distributed OSD lists of the placement groups PGs in the cluster storage pool, and entering Step S3. When hard disk replacement occurs, a recalculation of the OSD list of the placement groups PGs may occur.

Further, specific steps of Step S3 are as follows:
S31. calculating the difference items between the originally distributed OSD lists and the newly distributed OSD lists of the placement groups PGs and saving them;
S32. setting the placement groups PGs as primary keys; and
S33. recording difference item fields between the originally distributed OSD lists and the newly distributed OSD lists corresponding to each primary key, in the form of osd.x->osd.y, to generate the difference comparison table, wherein osd.x is hard disks in the newly distributed OSD lists corresponding to the placement groups PGs, and osd.y is hard disks in the originally distributed OSD lists corresponding to the placement groups PGs. The difference items of the occurring recalculation of the OSD list of the placement groups are found out by comparing.

Further, specific steps of Step S4 are as follows:
S41. traversing the difference comparison table to sequentially position and determine whether osd.x in the difference item fields corresponding to each placement group PG is replacement hard disks;
under a condition that osd.x in the difference item fields corresponding to each placement group PG is the replacement hard disks, entering Step S42;
under a condition that osd.x in the difference item fields corresponding to each placement group PG is not the replacement hard disks, entering Step S43;
S42. deleting the difference item fields corresponding to the placement group PG; and
S43. determining whether the positioning of each placement group PG is completed;
under a condition that the positioning of each placement group PG is completed, obtaining the placement groups PGs with extra OSD changes to generate the difference correction table, and entering Step S5;
under a condition that the positioning of each placement group PG is not completed, returning to step S41. The difference items belonging to the hard disk replacement are deleted, thereby the OSD needed to be corrected is obtained.

Further, specific steps of Step S5 are as follows:
S51. obtaining the difference correction table;
S52. sequentially positioning difference items osd.x->osd.y resulting from extra OSD changes in the difference correction table; and
S53. correcting the placement groups PGs with extra OSD changes to be originally distributed, that is, changing osd.x into osd.y. The OSD needed to be corrected is restored, thereby avoiding extra data migration and improving hard disk availability.

In a second aspect, the present disclosure provides a system for reducing reconstruct data due to storage medium changes in the storage cluster, including:
an originally distributed OSD list obtainment module configured for obtaining originally distributed OSD lists of placement groups PGs in a cluster storage pool;
a newly distributed OSD list obtainment module configured for obtaining newly distributed OSD lists of the placement groups PGs in the cluster storage pool when disk replacement occurs in the cluster storage pool;
a difference comparison table generation module configured for calculating difference items between the originally distributed OSD lists and the newly distributed OSD lists of the placement groups PGs to generate a difference comparison table;
a difference correction table generation module configured for traversing the difference comparison table to sequentially delete replacement hard disks, in the corresponding newly distributed OSD lists, of the difference items of each placement group PG, to obtain placement groups PGs with extra OSD changes, and generating a difference correction table; and
a difference correction module configured for applying the difference correction table to correct the placement groups PGs with extra OSD changes to be originally distributed.

Further, the newly distributed OSD list obtainment module (2) includes:
a disk replacement determination unit configured for determining whether the disk replacement occurs in the cluster storage pool; and
a newly distributed OSD list obtainment unit configured for obtaining the newly distributed OSD lists of the placement groups PGs in the cluster storage pool when the disk replacement occurs in the cluster storage pool.

Further, the difference comparison table generation module includes:
a difference item calculation unit configured for calculating the difference items between the originally distributed OSD lists and the newly distributed OSD lists of the placement groups PGs and saving them;
a primary key setting unit configured for setting the placement groups PGs as primary keys; and
a difference comparison table generation unit configured for recording difference item fields between the originally distributed OSD lists and the newly distributed OSD lists corresponding to each primary key, in the form of osd.x->osd.y, to generate the difference comparison table, wherein osd.x is hard disks in the newly distributed OSD lists corresponding to the placement groups PGs, osd.y is hard disks in the originally distributed OSD lists corresponding to the placement groups PGs.

Further, the difference correction table generation module (4) includes:
a replacement hard disk determination unit configured for traversing the difference comparison table to sequentially position and determine whether osd.x in the difference item fields corresponding to each placement group PG is the replacement hard disks;
a difference item field deletion unit configured for deleting the difference item fields corresponding to the placement group PG when osd.x in the difference item fields is the replacement hard disks;
a placement group PG positioning completion determination unit configured for determining whether the positioning of each placement group PG is completed; and
a difference correction table generation unit configured for obtaining the placement groups PGs with extra OSD changes when the positioning of each placement group PG is completed, to generate the difference correction table.

Further, the difference correction module includes:
a difference correction table obtainment unit configured for obtaining the difference correction table;
a difference-term-resulting-from-extra-OSD-changes obtainment unit configured for sequentially positioning the difference items osd.x->osd.y resulting from extra OSD changes in the difference correction table; and
a difference correction unit configured for correcting the placement groups PGs with extra OSD changes to be originally distributed, that is, changing osd.x into osd.y.

The beneficial effects of the present disclosure lie in that by calculating the originally distributed OSD lists of all the placement groups PGs in the storage cluster and the newly distributed OSD lists after the disk replacement, the method and system for reducing reconstruct data due to storage medium changes in the storage cluster provided by the present disclosure, may correct distribution changes resulting from the unstable algorithm, except for the placement groups PGs with distribution changes really resulting from hard disk replacement, through the form of the difference correction table for them to be originally distributed, thereby reducing the migration of cluster data and improving cluster availability.

In addition, the present disclosure has reliable design principles, simple structures and very broad application prospects.

It may be seen that the present disclosure has prominent substantive features and significant progress compared with the prior art, and the beneficial effects of its implementation are also obvious.

### BRIEF DESCRIPTION OF THE DRAWINGS

To illustrate the embodiments of the present application more clearly, a brief description will be given below of the drawings necessary for the embodiments. Apparently, the drawings in the following description are only some embodiments of the present application, and those of ordinary skill in the art may obtain other drawings based on these drawings without involving any inventive effort.

FIG. 1 is a first method flow chart of the present disclosure.

FIG. 2 is a second method flow chart of the present disclosure.

FIG. 3 is a system diagram of the present disclosure.

In the figures: 1-originally distributed OSD list obtainment module; 2-newly distributed OSD list obtainment module; 2.1-disk replacement determination unit; 2.2-newly distributed OSD list obtainment unit; 3-difference comparison table generation module; 3.1-difference item calculation unit; 3.2-primary key setting unit; 3.3-difference comparison table generation unit; 4-difference correction table generation module; 4.1- replacement hard disk determination unit; 4.2-difference item field deletion unit; 4.3-placement group PG positioning completion determination unit; 4.4-difference correction table generation unit; 5-difference correction module; 5.1-difference correction table obtainment unit; 5.2-difference-term-resulting-from-extra-OSD-changes obtainment unit; 5.3-difference correction unit.

### DETAILED DESCRIPTION OF THE EMBODIMENTS

In order that a person skilled in the art may understand the technical solution better in the present disclosure, a more complete description of the embodiments of the present disclosure will be rendered by reference to the appended drawings, which are provided for purposes of illustration and are not intended to be exhaustive of or limiting the present disclosure. All the other embodiments obtained by a person of ordinary skill in the art based on the embodiments in the present application without involving any inventive effort shall fall within the scope of the present application.

### Embodiment 1

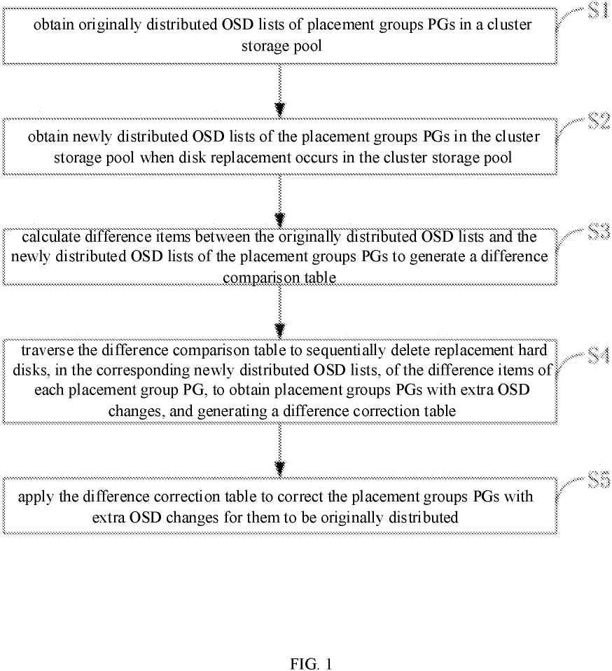

As shown in FIG. 1, the present disclosure provides a method for reducing reconstruct data due to storage medium changes in the storage cluster, including the following steps:
S1. obtaining originally distributed OSD lists of placement groups PGs in a cluster storage pool;
S2. obtaining newly distributed OSD lists of the placement groups PGs in the cluster storage pool when disk replacement occurs in the cluster storage pool;
S3. calculating difference items between the originally distributed OSD lists and the newly distributed OSD lists of the placement groups PGs to generate a difference comparison table;
S4. traversing the difference comparison table to sequentially delete replacement hard disks, in the corresponding newly distributed OSD lists, of the difference items of each placement group PG, to obtain placement groups PGs with extra OSD changes, and generating a difference correction table; and
S5. applying the difference correction table to correct the placement groups PGs with extra OSD changes for them to be originally distributed.

### Embodiment 2

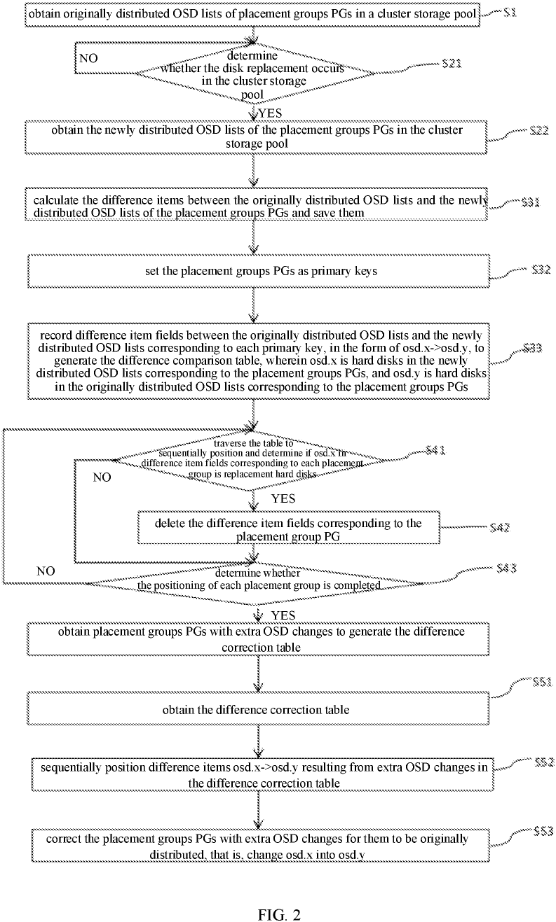

As shown in FIG. 2, the present disclosure provides a method for reducing reconstruct data due to storage medium changes in the storage cluster, including the following steps:
S1. obtaining originally distributed OSD lists of placement groups PGs in a cluster storage pool;
S2. obtaining newly distributed OSD lists of the placement groups PGs in the cluster storage pool when disk replacement occurs in the cluster storage pool, specific steps of which are as follows:
   S21. determining whether the disk replacement occurs in the cluster storage pool;
   under a condition that the disk replacement occurs in the cluster storage pool, entering Step S22;
   under a condition that the disk replacement does not occur in the cluster storage pool, returning to Step S21; and
   S22. obtaining the newly distributed OSD lists of the placement groups PGs in the cluster storage pool, and entering Step S3.
S3: calculating difference items between the originally distributed OSD lists and the newly distributed OSD lists of the placement groups PGs to generate a difference comparison table, specific steps of which are as follows:
   S31. calculating the difference items between the originally distributed OSD lists and the newly distributed OSD lists of the placement groups PGs and saving them;
   S32. setting the placement groups PGs as primary keys; and
   S33. recording difference item fields between the originally distributed OSD lists and the newly distributed OSD lists corresponding to each primary key, in the form of osd.x->osd.y, to generate the difference comparison table, wherein osd.x is hard disks in the newly distributed OSD lists corresponding to the placement groups PGs, and osd.y is hard disks in the originally distributed OSD lists corresponding to the placement groups PGs;
S4. traversing the difference comparison table to sequentially delete replacement hard disks, in the corresponding newly distributed OSD lists, of the difference items of each placement group PG, to obtain placement groups PGs with extra OSD changes, thereby generating a difference correction table, specific steps of which are as follows:
   S41. traversing the difference comparison table to sequentially position and determine whether osd.x in the difference item fields corresponding to each placement group PG is replacement hard disks;
   under a condition that osd.x in the difference item fields corresponding to each placement group PG is the replacement hard disks, entering Step S42;
   under a condition that osd.x in the difference item fields corresponding to each placement group PG is not the replacement hard disks, entering Step S43;
   S42. deleting the difference item fields corresponding to the placement group PG; and
   S43. determining whether the positioning of each placement group PG is completed;
   under a condition that the positioning of each placement group PG is completed, obtaining placement groups PGs with extra OSD changes to generate the difference correction table, and entering Step S5;
   under a condition that the positioning of each placement group PG is not completed, returning to step S41; and
S5. applying the difference correction table to correct the placement groups PGs with extra OSD changes for them to be originally distributed, specific steps of which are as follows:
   S51. obtaining the difference correction table;
   S52. sequentially positioning difference items osd.x->osd.y resulting from extra OSD changes in the difference correction table; and
   S53. correcting the placement groups PGs with extra OSD changes for them to be originally distributed, that is, changing osd.x into osd.y.

### Embodiment 3

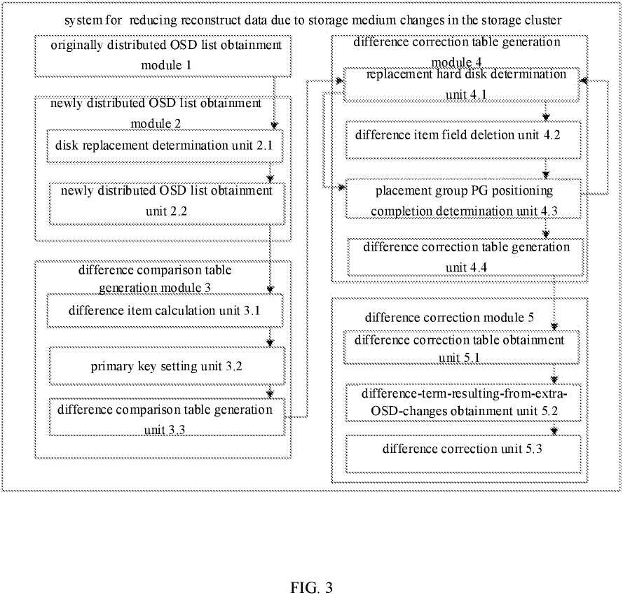

As shown in FIG. 3, the present disclosure provides a system for reducing reconstruct data due to storage medium changes in the storage cluster, including:
an originally distributed OSD list obtainment module 1 configured for obtaining originally distributed OSD lists of placement groups PGs in a cluster storage pool;
a newly distributed OSD list obtainment module 2 configured for obtaining newly distributed OSD lists of the placement groups PGs in the cluster storage pool when disk replacement occurs in the cluster storage pool; wherein the newly distributed OSD list obtainment module 2 includes
a disk replacement determination unit 2.1 configured for determining whether the disk replacement occurs in the cluster storage pool; and
a newly distributed OSD list obtainment unit 2.2 configured for obtaining the newly distributed OSD lists of the placement groups PGs in the cluster storage pool when the disk replacement occurs in the cluster storage pool;
a difference comparison table generation module 3 configured for calculating difference items between the originally distributed OSD lists and the newly distributed OSD lists of the placement groups PGs to generate a difference comparison table, wherein the difference comparison table generation module 3 includes:
   a difference item calculation unit 3.1 configured for calculating the difference items between the originally distributed OSD lists and the newly distributed OSD lists of the placement groups PGs and saving them;
   a primary key setting unit 3.2 configured for setting the placement groups PGs as primary keys; and
   a difference comparison table generation unit 3.3 configured for recording difference item fields between the originally distributed OSD lists and the newly distributed OSD lists corresponding to each primary key, in the form of osd.x->osd.y, to generate the difference comparison table, wherein osd.x is hard disks in the newly distributed OSD lists corresponding to the placement groups PGs, osd.y is hard disks in the originally distributed OSD lists corresponding to the placement groups PGs;
   a difference correction table generation module 4 configured for traversing the difference comparison table to sequentially delete replacement hard disks, in the corresponding newly distributed OSD lists, of the difference items of each placement group PG, to obtain placement groups PGs with extra OSD changes, thereby generating a difference correction table; wherein the difference correction table generation module 4 includes:
      a replacement hard disk determination unit 4.1 configured for traversing the difference comparison table to sequentially position and determine whether osd.x in the difference item fields corresponding to each placement group PG is the replacement hard disks;
      a difference item field deletion unit 4.2 configured for deleting the difference item fields corresponding to the placement group PG when osd.x in the difference item fields is the replacement hard disks;
      a placement group PG positioning completion determination unit 4.3 configured for determining whether the positioning of each placement group PG is completed; and
      a difference correction table generation unit 4.4 configured for obtaining the placement groups PGs with extra OSD changes when the positioning of each placement group PG is completed, to generate the difference correction table; and
      a difference correction module 5 configured for applying the difference correction table to correct the placement groups PGs with extra OSD changes for them to be originally distributed; wherein the difference correction module 5 includes:
         a difference correction table obtainment unit 5.1 configured for obtaining the difference correction table;
         a difference-term-resulting-from-extra-OSD-changes obtainment unit 5.2 configured for sequentially positioning the difference items osd.x->osd.y resulting from extra OSD changes in the difference correction table; and
         a difference correction unit 5.3 configured for correcting the placement groups PGs with extra OSD changes for them to be originally distributed, that is, changing osd.x into osd.y.

Although the present disclosure is described in detail by referring to the drawing and combining the embodiment, the present disclosure is not limited to this. Without departing from the spirit and substance of the present disclosure, a person skilled in the art may make various equivalent modifications or substitutions to the embodiment of the present disclosure, and these modifications or substitutions shall be within the coverage of the present disclosure or a person skilled in the art may easily think of changes or substitutions within the technical scope revealed by the present disclosure and shall be covered by the scope of protection of the present disclosure. Therefore, the scope of protection of the present disclosure shall be based on that of the claim.

1. A method for reducing reconstruct data due to storage medium changes in a storage cluster, comprising:
S1. obtaining originally distributed OSD lists of placement groups PGs in a cluster storage pool;
S2. obtaining newly distributed OSD lists of the placement groups PGs in the cluster storage pool when disk replacement occurs in the cluster storage pool;
S3. calculating difference items between the originally distributed OSD lists and the newly distributed OSD lists of the placement groups PGs to generate a difference comparison table;
S4. traversing the difference comparison table to sequentially delete replacement hard disks, in the corresponding newly distributed OSD lists, of the difference items of each placement group PG, to obtain placement groups PGs with extra OSD changes, and generating a difference correction table; and
S5. applying the difference correction table to correct the placement groups PGs with extra OSD changes to be originally distributed.

2. The method for reducing reconstruct data due to storage medium changes in the storage cluster according to claim 1, wherein steps of Step S2 comprises:
S21. determining whether the disk replacement occurs in the cluster storage pool;
under a condition that the disk replacement occurs in the cluster storage pool, entering Step S22;
under a condition that the disk replacement does not occur in the cluster storage pool, returning to Step S21; and
S22. obtaining the newly distributed OSD lists of the placement groups PGs in the cluster storage pool, and entering Step S3.

3. The method for reducing reconstruct data due to storage medium changes in the storage cluster according to claim 1, wherein steps of Step S3 comprises:
S31. calculating the difference items between the originally distributed OSD lists and the newly distributed OSD lists of the placement groups PGs and saving them;
S32. setting the placement groups PGs as primary keys; and
S33. recording difference item fields between the originally distributed OSD lists and the newly distributed OSD lists corresponding to each primary key, in the form of osd.x->osd.y, to generate the difference comparison table, wherein osd.x is hard disks in the newly distributed OSD lists corresponding to the placement groups PGs, and osd.y is hard disks in the originally distributed OSD lists corresponding to the placement groups PGs.

4. The method for reducing reconstruct data due to storage medium changes in the storage cluster according to claim 3, wherein steps of Step S4 comprises:
S41. traversing the difference comparison table to sequentially position and determine whether osd.x in the difference item fields corresponding to each placement group PG is replacement hard disks;
under a condition that osd.x in the difference item fields corresponding to each placement group PG is the replacement hard disks, entering Step S42;
under a condition that osd.x in the difference item fields corresponding to each placement group PG is not the replacement hard disks, entering Step S43;
S42. deleting the difference item fields corresponding to the placement group PG; and
S43. determining whether the positioning of each placement group PG is completed;
under a condition that the positioning of each placement group PG is completed, obtaining the placement groups PGs with extra OSD changes to generate the difference correction table, and entering Step S5;
under a condition that the positioning of each placement group PG is not completed, returning to step S41.

5. The method for reducing reconstruct data due to storage medium changes in the storage cluster according to claim 4, wherein steps of Step S5 comprises:
S51. obtaining the difference correction table;
S52. sequentially positioning difference items osd.x->osd.y resulting from extra OSD changes in the difference correction table; and
S53. correcting the placement groups PGs with extra OSD changes to be originally distributed, that is, changing osd.x into osd.y.

6. A system for reducing reconstruct data due to storage medium changes in the storage cluster, comprising: a processor; and
a memory, storing a computer program that is executed by the processor, and upon execution by the processor, is configured to cause the processor to:
obtain originally distributed OSD lists of placement groups PGs in a cluster storage pool;
obtain newly distributed OSD lists of the placement groups PGs in the cluster storage pool when disk replacement occurs in the cluster storage pool;
calculate difference items between the originally distributed OSD lists and the newly distributed OSD lists of the placement groups PGs to generate a difference comparison table;
traverse the difference comparison table to sequentially delete replacement hard disks, in the corresponding newly distributed OSD lists, of the difference items of each placement group PG, to obtain placement groups PGs with extra OSD changes, and generating a difference correction table; and
apply the difference correction table to correct the placement groups PGs with extra OSD changes to be originally distributed.

7. The system for reducing reconstruct data due to storage medium changes in the storage cluster according to claim 6, wherein the operation of obtaining newly distributed OSD lists of the placement groups PGs in the cluster storage pool when disk replacement occurs in the cluster storage pool comprises:
determining whether the disk replacement occurs in the cluster storage pool; and
obtaining the newly distributed OSD lists of the placement groups PGs in the cluster storage pool when the disk replacement occurs in the cluster storage pool.

8. The system for reducing reconstruct data due to storage medium changes in the storage cluster according to claim 6, wherein the operation of calculating difference items between the originally distributed OSD lists and the newly distributed OSD lists of the placement groups PGs to generate a difference comparison table comprises:
calculating the difference items between the originally distributed OSD lists and the newly distributed OSD lists of the placement groups PGs and saving them;
setting the placement groups PGs as primary keys; and
recording difference item fields between the originally distributed OSD lists and the newly distributed OSD lists corresponding to each primary key, in the form of osd.x->osd.y, to generate the difference comparison table, wherein osd.x is hard disks in the newly distributed OSD lists corresponding to the placement groups PGs, osd.y is hard disks in the originally distributed OSD lists corresponding to the placement groups PGs.

9. The system for reducing reconstruct data due to storage medium changes in the storage cluster according to claim 6, wherein the operation of traversing the difference comparison table to sequentially delete replacement hard disks, in the corresponding newly distributed OSD lists, of the difference items of each placement group PG, to obtain placement groups PGs with extra OSD changes, and generating a difference correction table comprises:
traversing the difference comparison table to sequentially position and determine whether osd.x in the difference item fields corresponding to each placement group PG is the replacement hard disks;
deleting the difference item fields corresponding to the placement group PG when osd.x in the difference item fields is the replacement hard disks;
determining whether the positioning of each placement group PG is completed; and
obtaining the placement groups PGs with extra OSD changes when the positioning of each placement group PG is completed, to generate the difference correction table.

10. The system for reducing reconstruct data due to storage medium changes in the storage cluster according to claim 6, wherein the operation of applying the difference correction table to correct the placement groups PGs with extra OSD changes to be originally distributed comprises:
obtaining the difference correction table;
sequentially positioning the difference items osd.x->osd.y resulting from extra OSD changes in the difference correction table; and
correcting the placement groups PGs with extra OSD changes to be originally distributed, that is, changing osd.x into osd.y.

11. A non-transitory computer readable storage medium storing computer program that, when executed by a processor, causes the processor to:
obtain originally distributed OSD lists of placement groups PGs in a cluster storage pool;
obtain newly distributed OSD lists of the placement groups PGs in the cluster storage pool when disk replacement occurs in the cluster storage pool;
calculate difference items between the originally distributed OSD lists and the newly distributed OSD lists of the placement groups PGs to generate a difference comparison table;
traverse the difference comparison table to sequentially delete replacement hard disks, in the corresponding newly distributed OSD lists, of the difference items of each placement group PG, to obtain placement groups PGs with extra OSD changes, and generating a difference correction table; and
apply the difference correction table to correct the placement groups PGs with extra OSD changes to be originally distributed.

12. The non-transitory computer-readable storage medium according to claim 11, wherein the operation of obtaining newly distributed OSD lists of the placement groups PGs in the cluster storage pool when disk replacement occurs in the cluster storage pool comprises:
determining whether the disk replacement occurs in the cluster storage pool; and
obtaining the newly distributed OSD lists of the placement groups PGs in the cluster storage pool when the disk replacement occurs in the cluster storage pool.

13. The non-transitory computer-readable storage medium according to claim 11, wherein the operation of calculating difference items between the originally distributed OSD lists and the newly distributed OSD lists of the placement groups PGs to generate a difference comparison table comprises:
calculating the difference items between the originally distributed OSD lists and the newly distributed OSD lists of the placement groups PGs and saving them;
setting the placement groups PGs as primary keys; and recording difference item fields between the originally distributed OSD lists and the newly distributed OSD lists corresponding to each primary key, in the form of osd.x->osd.y, to generate the difference comparison table, wherein osd.x is hard disks in the newly distributed OSD lists corresponding to the placement groups PGs, osd.y is hard disks in the originally distributed OSD lists corresponding to the placement groups PGs.

14. The non-transitory computer-readable storage medium according to claim 11, wherein the operation of traversing the difference comparison table to sequentially delete replacement hard disks, in the corresponding newly distributed OSD lists, of the difference items of each placement group PG, to obtain placement groups PGs with extra OSD changes, and generating a difference correction table comprises:
traversing the difference comparison table to sequentially position and determine whether osd.x in the difference item fields corresponding to each placement group PG is the replacement hard disks;
deleting the difference item fields corresponding to the placement group PG when osd.x in the difference item fields is the replacement hard disks;
determining whether the positioning of each placement group PG is completed; and
obtaining the placement groups PGs with extra OSD changes when the positioning of each placement group PG is completed, to generate the difference correction table.

15. The non-transitory computer-readable storage medium according to claim 11, wherein the operation of applying the difference correction table to correct the placement groups PGs with extra OSD changes to be originally distributed comprises:
obtaining the difference correction table;
sequentially positioning the difference items osd.x->osd.y resulting from extra OSD changes in the difference correction table; and
correcting the placement groups PGs with extra OSD changes to be originally distributed, that is, changing osd.x into osd.y.

16. The non-transitory computer-readable storage medium according to claim 11, wherein when hard disk replacement occurs, a recalculation of the OSD list of the placement groups PGs occurs.

17. The non-transitory computer-readable storage medium according to claim 11, wherein the difference items of the occurring recalculation of the OSD list of the placement groups are found out by comparing.

18. The non-transitory computer-readable storage medium according to claim 11, wherein the difference items belonging to the hard disk replacement are deleted, thereby the OSD needed to be corrected is obtained.

19. The non-transitory computer-readable storage medium according to claim 11, wherein the OSD needed to be corrected is restored, thereby avoiding extra data migration and improving hard disk availability.

20. The system for reducing reconstruct data due to storage medium changes in the storage cluster according to claim 6, wherein when hard disk replacement occurs, a recalculation of the OSD list of the placement groups PGs occurs.
